(19) United States
(12) Patent Application Publication
(10) Pub. No.: US 2010/0112453 A1
(43) Pub. Date: May 6, 2010

(54) ELECTRODES FOR AN ELECTRIC FACILITY, SUCH AS A LITHIUM-ION CELL, OPERATING ACCORDING TO GALVANIC PRINCIPLES, AND METHODS OF MAKING THE SAME

(76) Inventors: Andreas Gutsch, Ludinghausen (DE); Tim Schäfer, Niedersachswerfen (DE)

Correspondence Address: CHOATE, HALL & STEWART LLP, TWO INTERNATIONAL PLACE, BOSTON, MA, 02110, US

(21) Appl. No.: 12/604,533

(22) Filed: Oct. 23, 2009

(30) Foreign Application Priority Data
Oct. 23, 2008 (DE) 102008053009.3

(51) Int. Cl. H01M 4/58; H01M 6/00; B32B 38/00; B32B 37/02

(52) U.S. Cl. 429/231.95; 29/623.1; 156/64

(57) ABSTRACT

A method of making an electrode for a device operating according to galvanic principles, in particular a lithium-ion cell, comprises the steps of: (i) making a sheet-like electrode (2), (ii) detecting where one or more imperfections (4, 4′, 4″) exist on said sheet-like electrode, and (iii) with respect to a respectively detected imperfection (4, 4′, 4″), correcting a surrounding area (6, 6′) of the imperfection (4, 4′, 4″) including said imperfection. Based on the result of detection step (ii), at least a portion (8, 8′, 8″) of the laminar electrode may be provided that has no imperfection.

In an electrode made according to the method, in particular cathode or anode, for a device operating according to galvanic principles, in particular a lithium-ion cell comprising an electrode material that is arranged in a sheet-like manner, the electrode material is composed of at least a first, in particular slat-like portion (22-1), which is free from imperfections, and a second, in particular slat-like portion (22-2), which is free from imperfections.

A device operating according to galvanic principles, in particular a lithium-ion cell, comprises the following layers, which are arranged one upon the other: a first electrode (32), which is free from imperfections, which comprises at least two assembled portions, which are free from imperfections, a separator layer (50) comprising a separator material (16) that is developed in a sheet-like manner, and a second electrode, which is free from imperfections, which consists of a one-piece portion or which comprises at least two assembled portions, which are free from imperfections, and which is complementary to the first electrode.

The present invention relates to a method of making an electrode for a device operating according to galvanic principles, in particular a lithium-ion cell, to an electrode, which is made according to said method, to a method of making a device operating according to galvanic principles, in particular a lithium-ion cell, and to a device made according to said method.

In many instances, electrodes, in particular cathodes and anodes for devices operating according to galvanic principles, such as in particular lithium-ion cells, are made in a web-like or sheet-like manner, and are processed in the form of sheets, respectively slats. Thereby, imperfections in the electrodes, which are provided in a sheet-like manner as described, result in a malperformance of a device, respectively cell, which is made by using said electrode, or even result in the breakdown of the device, respectively the cell, respectively an accumulator, which is produced from the same. Such devices, respectively accumulators, must be disposed, which is an economic draw-back.

It is an object of the invention to prevent the subsequent processing of electrodes comprising imperfections, which are provided in a sheet-like manner, and thereby to avoid the described economic draw-back. This object is achieved by the method of making an electrode, respectively by a method of making a device operating according to galvanic principles, and by electrodes made according to said methods, respectively by devices operating according to galvanic principles, according to the features of the attached patent claims.

In general, the solution according to the invention of said object consists therein to detect imperfections in the electrodes, respectively electrode layers, which are made in a sheet-like manner. The detected imperfections, respectively the regions surrounding said detected imperfections, of the electrode, respectively electrode layer, which are made in a sheet-like manner, may be removed. Also, regions, respectively sections, of the electrodes, respectively electrode layers in which no imperfections could be detected, may be fed to the further subsequent processing, respectively use, that is to the completing of electrodes and to the assembling of devices operating according to galvanic principles. Thereby, one-piece electrodes, which have been rated during the detecting to be without imperfections, can be selected for the further processing. However, also detected imperfections, respectively regions containing detected imperfections, may be repaired, or may be removed. After the removal, such as by detaching imperfections, respectively regions containing imperfections, portions without imperfections that are generated thereby, may be connected to each other in order to provide larger regions without imperfections for the further processing, respectively for the application.

According to a first aspect of the invention, as claimed, a method of making an electrode for a device operating according to galvanic principles is provided, in particular for a lithium-ion cell. The method comprises (i) the making of a sheet-like electrode. According to the invention, (ii) it is detected whether and, if indicated, where one or several imperfections are present on the sheet-like electrode. Furthermore, (iii) for a respectively detected imperfection, a surrounding of the imperfection including said imperfection is removed.

Thus, based on the result of the detection step, at least a portion or several portions of the sheet-liker electrode without imperfection, a so-called portion without imperfections, respectively several portions without imperfections, may be provided.

An advantage of the method according to the invention consists therein that in the detection step the sheet-like electrode is tested for whether and where on said sheet-like electrode probably imperfections are present. If in the detection step no imperfection is detected, respectively is discovered, the portion that has been tested in the detection step is considered to be without imperfections, and is provided as region, respectively portion without imperfection for the subsequent processing. If in the testing in the detection step one or several imperfections are identified, said imperfection including the surrounding of said imperfection is removed such that only portions of the sheet-like electrode remain for which portions no imperfections have been identified in the detection step, and which consequently have been rated to be without imperfections. Only the detected, respectively rated portions without imperfections, are provided for the subsequent processing.

In general, the removal of the imperfection including a surrounding of the imperfection may be effected thereby that said imperfection, respectively said surrounding of the imperfection including said imperfection, is removed from the sheet-like electrode without replacement, in particular is detached, for example is cut out or is stamped out, or is replaced by a portion without imperfections, or is effected thereby that said imperfection is repaired.

Herein, a sheet-like electrode means an arrangement of electrode material, which is distributed across an area, in particular material for forming an active mass of a cathode, respectively anode, for a device operating according to galvanic principles, in particular a lithium-ion cell. The material may be applied in the form of a sheet in a self-supporting manner, or may be supported by a substrate, respectively may be applied onto a substrate. The substrate may serve as a diverting facility for diverting electric current from the electrode material and, for example, may be developed as metal foil, in particular as copper foil, respectively aluminium foil. The electrode material may be applied onto the substrate, in particular the diverting facility, on one side or also on two sides.

If the electrode material is applied onto both sides of a substrate, then the detection step comprises the testing of both sides, respectively the detecting of the layer of the electrode material, which is applied on the one side, and the detecting of the layer of the electrode material, which is applied on the opposite side of the substrate, for the presence of imperfections on the electrode material, respectively the position thereof.

An imperfection, respectively an imperfection of a sheet-like electrode, means an imperfection of the electrode material, which is distributed in a sheet-like manner. An imperfection in an electrode material, which is distributed in a sheet-like manner, means a location, respectively a locatable, respectively locally limited region of the electrode material, which is distributed in a sheet-like manner, in which a local deviation of any parameter of the layer, which is formed by the electrode material, from a defined average value of this parameter occurs with regard to a larger area, wherein the deviation is so high that a malperformance, respectively a break-down of the electrode, respectively the device, respectively the cell that have been made by using said electrode, has to be taken into account. A parameter characterizing an imperfection of the layer, which is formed by the electrode material, may be a film thickness, a mass per area, a grain size distribution, respectively a particle size distribution, a layer porosity, an overlapping degree for example of the substrate, an average particle distance, or any measurable parameter in a measurement method for the testing for homogeneity of the electrode material layer.

The surrounding of the imperfection herein means a portion adjoining the imperfection, or comprising the imperfection of the sheet-like electrode, wherein the parameter describing in the portion the structure of the sheet-like electrode, respectively the electrode material, which is distributed in a sheet-like manner, respectively the homogeneity of the layer, due to the presence of the imperfection may deviate from the parameter, which is averaged across a larger area, and wherein in the edge of the portion facing away from said imperfection, the sheet-like electrode, respectively electrode material layer, is rated to be without imperfections.

In the making step (step i), the sheet-like electrode may be made in a web-like manner, for example in a continuous method. A making in a web-like manner is particularly efficient and economic due to the possible relatively long continuous operating times of the making device.

In the making step (step i), the sheet-like electrode may be made also in the form of a sheet, for example in a stacking method, respectively batch method. A making in the form of a sheet allows a variation from sheet to sheet regarding the electrode type, the size of the used electrode material, respectively the parameter of the layer, such as the layer weight per area, the porosity or thickness of the layer.

In the detection step (step ii), a method of detecting imperfections may be selected from a group comprising the following: an optical method, a method comprising the analysis of microscopically magnified images of regions of the sheet-like electrode, a method comprising measurements of an electric conductivity of regions of the sheet-like electrode, a method comprising measurements of a dielectric capacity of regions of the sheet-like electrode, or combinations thereof. The methods being comprised by said group are contact-free methods, which are suitable for the testing of area regions, which are relatively large compared to typically occurring imperfections and which, for example, are suitable for shifting a measurement window across the surface of the sheet-like electrode for sampling, respectively scanning, the total surface of the sheet-like electrode.

An optical method of detecting imperfections may comprise the recording of an image of a region of the sheet-like electrode, and the recognition of a local deviation of a value of an image parameter, which is particularly indicative for an imperfection, from an average value of said image parameter, which has been determined across a relatively large area. Thereby, in particular, the image may be recorded in reflection or in transmission. For example, the image parameter can be a brightness or a contrast. The image parameter can be representative for a parameter of the layer such as the layer thickness, the mass per area, the porosity, or homogeneity of the layer. The optical method can be carried out automatedly, or controlled by a person. In particular, the recognition of the local deviation can be carried out automatedly, e.g. by using a software for image processing, or may be visually carried out by a person.

The method comprising the measurement of the electric conductivity may comprise the measurement of an electric resistance of a region of the sheet-like electrode. Thereby, the region may essentially be slat-like, and the conductivity may particularly be measured in longitudinal direction of the slat-like region. For measuring the electric resistance of a section of the sheet-like electrode, said section may be contacted with measuring electrodes at front sides facing each other. For scanning a larger area, the recorded region, which is recorded by contacting, may be shifted, for example by removing the measuring electrodes, and recontacting in a new position. The electric resistance of a section depends on the layer thickness and the porosity, respectively the mass per area and, if an imperfection is present, may locally deviate from a large-scale average value, and thus may be indicative for an imperfection.

The method comprising the analysis of microscopically magnified images may comprise the recording of a magnified image of a region of the sheet-like electrode and, due to the in particular sequential recording of images in several, suitably positioned regions, the scanning of the in particular essentially whole surface of the sheet-like electrode. This may be carried out by means of an optical microscope, or by means of a scanning electron micrograph. By means of the microscopic magnification, also spatially very limited imperfections, respectively very small imperfections may be detected.

The method comprising the measurement of the dielectric capacity may comprise the measurement of the dielectric capacity of a respective region, which is present in the measurement window of the sheet-like electrode and, due to the in particular sequential measuring of the dielectric capacity in several, suitably positioned measurement windows, the scanning of the in particular essentially whole surface of the sheet-like electrode. The dielectric capacity of a section of the sheet-like electrode depends on the layer thickness and the porosity, respectively the mass per area of the electrode material, and may be indicative for the presence of an imperfection. Measurements of the dielectric capacity are particularly suitable for an automated detection method.

The making step of the sheet-like electrode may comprise the application of a layer of an electrode material onto a substrate. The electrode material may be a material, which is suitable for forming a cathode, a so-called cathode material, or a material suitable for forming an anode, a so-called anode material. The substrate in particular may be a material diverting the electric current, in particular a metal foil. The substrate serves as support of the electrode material, which is distributed in a sheet-like manner, and serves for stabilizing the layer of the electrode material. It may facilitate the handling of the sheet-like electrode in the subsequent processing.

If the sheet-like electrode is made in the form of electrode material, which is distributed on a substrate as support, in the removal step of a surrounding of the imperfection (removal step), a section of the layer of the electrode material, which contains said imperfection, may be removed from the substrate, and in the uncovered section a fresh electrode layer may be applied onto the substrate. Preferably, still in the applied fresh electrode layer, it is detected whether and where one or more imperfections are present therein. In this manner, an imperfection may be repaired, wherein the substrate is further used without loss, and in particular no joint is produced within the substrate.

In the removal step (step iii), a region containing the imperfection of the sheet-like electrode may be removed, respectively may be detached from the sheet-like electrode, and may be replaced by a region without imperfection, which corresponds to the form of the removed region, respectively detached region, and which is derived from the same or from another sheet-like electrode. This allows that the regions, which originally have been made without imperfection, may be further used as far as possible for the assembly of a device, respectively a cell, operating according to galvanic principles, and that for the subsequent processing relatively large-scale regions without imperfections are provided.

Alternatively, in the removal step (step iii), a region containing a detected imperfection of the sheet-like electrode may be detached from the sheet-like electrode along separation lines. Preferably, said portion is slat-like and, in particular, the separation lines are essentially parallel to each other. Slats are particularly easy to handle, and in essential comprise linear longitudinal sides, which can be easily connected to each other. Cutting out or stamping out may effect the detachment. If in the detaching of a region of the sheet-like electrode containing a detected imperfection, two portions without imperfection are created, the generated portions may easily and positively be assembled along the separation lines. In this manner, the regions without imperfections essentially may be subsequently used, and a relatively large region without imperfections of the sheet-like electrode may be obtained by the assembling for the subsequent processing.

The method further may comprise the assembling of two sections without imperfections of the same sheet-like electrode, or of two different sheet-like electrodes, in particular along respective edges, respectively separation lines of the sections. Also in this manner, relatively large regions without imperfections may be provided, which are larger than the regions without imperfections that have directly been generated in the making step. Furthermore, it is possible to combine regions without imperfections from different sheet-like electrodes, which may originate from different making steps, respectively methods, comprising different making parameters, to an electrode.

The assembling may comprise a contacting of the edges of the regions to be assembled in a stack-like manner. Therefore, at the joint a local increase of the thickness due to the joint of the sheet-like electrode can be avoided, and in particular in assembling sections comprising the same thickness an essentially constant thickness at the joint may be achieved.

Alternatively, the assembling may comprise an overlapping contacting of respective, in particular edge slats running along the edges of the regions to be assembled. By means of the overlapping, a tighter, respectively deeper connection of the sections to be assembled may be achieved.

After the removal step (step iii), at least a portion of the provided sheet-like electrode without imperfections may be coiled up. After the removal step, also a layer of a separator material, which in particular is provided in a sheet-like manner, may be applied onto at least one region of the sheet-like electrode without imperfections, and at least a portion of the region, which is provided with the separator material of the sheet-like electrode, may be coiled up. By means of the coiling up, a compact construction of the electrode is obtained.

Alternatively to the coiling up, the method may comprise the following steps, which have to be carried out after the removal step (step iii): folding the sheet-like electrode in regular distances and along folding lines, which are essentially arranged in parallel towards each other alternating into a first direction and into a second direction, which is opposite to the first direction, forming a stack of regions, which are arranged one upon the other, and which are connected to each other at a folding line, respectively, of the sheet-like electrode. Also in this manner, one obtains a compact construction of the electrode comprising regions in the form of an accordion, respectively regions comprising in the cross-section a M-shaped profile. In particular, in the thus developed stack, furthermore, separator material that is developed in a sheet-like can be inserted, and in fact between the sections of the sheet-like electrode, which are arranged one upon the other, respectively, in particular in the form of sheets of separator material, which are congruently developed with regard to two respective sections, which are arranged one upon the other.

According to a second aspect of the invention, a method of making an electrode for a device operating to galvanic principles is provided, in particular for a lithium-ion cell. The method comprises the making of a sheet-like electrode. According to the invention, the method further comprises detecting whether and, if indicated, where on the sheet-like electrode one or several imperfections are present, and furthermore on the basis of the results of the detection steps, the provision of at least one portion without imperfections of the sheet-like electrode. Preferably, the portion is slat-like.

An advantage of this method is that a portion, which is provided by said method, has been tested in the detection step (step ii) for the presence of imperfections, and has been rated to be without imperfections.

The term “without imperfections” means that on a sheet-like electrode, respectively on a portion thereof, when carrying out the detection step, respectively in the testing, respectively detecting, whether and, if indicated, where on the sheet-like electrode one or several imperfections are present, with the used detection method and within the scope of the measuring precision no imperfection could be proved, respectively could be detected.

An arrangement one upon the other means herein an arrangement of several sheet-like layers, respectively sheet-like elements one upon the other, wherein between the layers, respectively elements, which are arranged one upon the other, also clearances may be present, i.e., the layers, respectively elements, do not necessarily contact each other. In the meaning of the present invention, an arrangement one upon the other comprises a stack, however, herein the term “stack” is independent from the space directions vertical and horizontal, respectively above and below.

The method according to the second aspect may further comprise: connecting at least a portion of an edge of a first portion without imperfections of the sheet-like electrode to at least one portion of an edge of a second portion without imperfections of the same or of a second sheet-like electrode along respective positive portions of the edges of the first and second portion.

In particular, a portion may be a slat-like portion, and an edge, respectively section of an edge, may at least be sectionally linear. By means of the connection of two portions without imperfections, a sheet-like electrode may be provided, which all in all is without imperfections, whose area is larger than the area of a portion without imperfections, which is restricted due to the manufacturing process with regard to the area.

In the method according to the second aspect, the first and the second portion as well as a third portion without imperfections of the first, second or a third sheet-like electrode may be developed in a slat-like manner, respectively, and the method may further comprise: connecting at least one portion of the edge of the third portion to at least one portion of the edge of the second portion, which faces the portion of the edge of the second portion, which is connected to the first portion. In this manner, an electrode may be provided, which is assembled from three portions, and which all in all is without imperfections. Also in this manner a fourth and further sections may be added.

Still according to the second aspect of the invention, a method of making a cell operating to galvanic principles is provided, in particular a method of making a lithium-ion cell, which comprises the following steps: connecting two, three, four, or more portions of a sheet-like electrode without imperfections, in particular portions of a sheet-like electrode, which are made according to the method according to the second aspect of the invention, and forming an electrode, which is assembled from portions, forming an arrangement one upon the other comprising the assembled electrode as first layer, a separator layer from separator material, which is provided in a sheet-like manner, as second layer, and an electrode as third layer, which is made from a one-piece portion without imperfections, and which is complementary to the assembled electrode.

In this method, the assembled electrode may be a cathode, respectively an anode. The electrode being complementary thereto is then an anode, respectively cathode.

A complementary electrode herein means an electrode, which has the antipodal polarity with regard to another electrode. If the other electrode in particular is an anode, then the electrode being complementary thereto is a cathode, and if the other electrode is a cathode, the electrode being complementary thereto is an anode.

A one-piece portion is herein a portion which, in the detection step, has been rated to be without imperfections as a whole, i.e., that is not assembled from two or more portions, which have been rated in the detection step to be without imperfections.

Therefore, in this method, an electrode, which is assembled from several portions, is confronted with a complementary one-piece electrode, respectively is assembled with this electrode to a device operating according to galvanic principles.

This method is particularly efficient and economic, since it allows the use of also relatively small portions without imperfections for the forming of an electrode, which all in all is without imperfections. Surprisingly, it has been discovered that said method is particularly advantageous if the assembled electrode is the positive electrode, respectively is the cathode.

According to the first aspect and the second aspect, a method of making a device operating according to galvanic principles is provided, in particular a lithium-ion cell, which comprises the following steps: forming an arrangement one upon the other of a portion of a sheet-like electrode comprising cathode material (cathode), which has been made according to the above described method according to the first aspect, separator material, which is provided in a sheet-like manner, and a portion of a sheet-like electrode comprising anode material (anode), which in particular has been made according to the above described method according to the first aspect.

Furthermore, a method of making a cell operation to galvanic principles is provided, in particular a lithium-ion cell, which comprises the following steps: connecting two, three, four, or more portions of sheet-like electrodes without imperfections comprising cathode material, which in particular have been made according to the method according to the second aspect, and forming a sheet-like cathode, which is assembled from said portions, connecting two, three, four, or more portions of sheet-like electrodes comprising anode material without imperfections, and which have been made according to the method of the second aspect, and forming a sheet-like anode, which is assembled from said portions, and forming an arrangement one upon the other consisting of the assembled cathode as the first layer, a separator layer from separator material, which is provided in a sheet-like manner as second layer, and the assembled anode as third layer.

Also this method is particularly efficient and economic, since relatively small portions are assembled to a relatively large sheet-like electrode without imperfections. Thus, said method is particularly tolerant also in the appearance of relatively high imperfection frequencies during the making of a respective electrode (cathode, respectively anode), since the detected imperfections and/or the surroundings thereof are removed, and the remaining portions without imperfections are connected to each other.

Advantageously, the two, three, four, or more portions comprising anode material can be congruently developed to respective two, three, four, or more portions comprising cathode material, respectively. Furthermore, the respective portions comprising cathode material, which are congruent to each other, and portions comprising anode material, may be congruently arranged one upon the other in the arrangement one upon the other with separator material, which is arranged between.

This method institutes a new design possibility for a device operating according to galvanic principles. Advantageous properties of different electrode materials may be combined with each other in an advantageous manner, respectively can be mixed, wherein portions made from the different electrode materials are connected to each other to an electrode. The thus made electrode then has the advantageous properties of the different electrode materials in combination. Thus, for example, for a first electrode, a first electrode material, which allows a particular high energy storage density, or that allows during discharge a low decrease of the voltage of the device, respectively cell, or that has a particularly developed capability for the provision of high current values, in particular peak current values, may be connected, respectively combined, to a second electrode material, which has another particularly developed property, which is different from the particularly developed property of the first electrode material.

The two, three, four, or more portions comprising cathode material, and the two, three, four, or more portions comprising anode material, may be slat-like portions, respectively. By using slat-like portions, the area portions of different electrode materials and thus the mixed, respectively combined property of an assembled electrode, may be particularly easily set, for example by setting the area portions, in particular for slat-like portions of the width of the area portions.

Furthermore, a method of making a device operating according to galvanic principles is provided, in particular a lithium-ion cell, which comprises the following steps: providing first slat-like portions comprising a first cathode material without imperfections, in particular made according to the method according to the second aspect of the invention, providing second slat-like portions comprising a second cathode material without imperfections, in particular made according to the method according to the second aspect, providing first slat-like portions comprising a first anode material without imperfections, in particular made according to the method according to the second aspect of the invention, providing second slat-like portions comprising a second anode material without imperfections, in particular made according to the method according to the second aspect, forming a sheet-like cathode from portions, which are arranged in parallel to each other, and which are connected to each other, wherein the first portions comprising the first cathode material and the second portions comprising the second cathode material are alternately connected to each other, forming a sheet-like anode from portions, which are arranged in parallel to each other, wherein the first portions comprising the first anode material and the second portions comprising the second anode material are alternately connected to each other, and forming an arrangement one upon the other consisting of the cathode as first layer, a separator layer from separator material, which is provided in a sheet-like manner, as second layer, and the anode as third layer. This method allows in the cathode, respectively in the anode, the advantageous combination of two different, particularly advantageous properties of two different electrode materials, such as the property of a relatively low voltage decrease during the discharge of the device (for example as first advantageous property), and the property to be able to provide relatively high current peak values as for example second advantageous property.

In said method, the respective slat-like portions of the cathode and the slat-like portions of the anode may be congruently arranged one upon the other in the arrangement one upon the other comprising separator material, which is arranged between. In this manner, portions comprising different advantageous properties in the cathode may be confronted with respective portions in the anode comprising comparably different features, and thus portions of the cell, which are optimized according to said different features, may be spatially arranged side by side, respectively may be designed.

Thereby, the first cathode material and the second cathode material may be the same cathode material. Thereby, another variation in the thickness in the two different portions is possible. In particular, the first slat-like portions of the cathode may comprise the first cathode material in a first thickness, and the second slat-like portions of the cathode may comprise the second cathode material in a second thickness.

Also the first anode material and the second anode material may be the same anode material. Also, thereby, still a variation in the thickness of the portions of the anode is possible. In particular, the first slat-like portions of the anode may comprise the first anode material in a third thickness, and the second slat-like portions of the anode may comprise the second anode material in a fourth thickness. In this arrangement, in particular portions comprising the cathode material in the relatively larger thickness may be congruently arranged in the arrangement one upon the other with regard to the portions of the anode comprising the anode material in the relatively larger thickness. Thereby, anode and cathode portions comprising the relatively larger thickness are confronted to each other, respectively.

According to a third aspect of the invention, an electrode, which in particular may be a cathode or an anode, is provided for a device operating according to galvanic principles, in particular a lithium-ion cell. The electrode comprises electrode material that is arranged in a sheet-like manner. According to the invention, the electrode material comprises a first portion without imperfections, and a second portion without imperfections. Thereby, the first portion comprises a first edge section, and the second portion comprises a second edge section, which is positively developed with regard to the first edge section.

For this electrode, the first portion and the second portion may be connected to each other along at least sections of the first and second edge section. Such an electrode, which is provided from assembled portions, allows a particularly economic making process thereby that for the occurrence of one or several imperfections, after removal of the imperfection/imperfections, respectively the portion/portions surrounding the imperfections, remaining portions without imperfections may be used in order to provide an electrode, which all in all is without imperfections.

As mentioned above, the term “without imperfections” means that the first portion and the second portion have been rated as result of a test method (detection step ii) to be without imperfections, in which has been detected whether and, if indicated, where on the sheet-like electrode material one or more imperfections are present.

In particular both the first as well as the second portion without imperfections might have been made according to the method according to the first, respectively second aspect of the present invention. Thereby, it is ensured that a testing for absence of imperfections within the scope of the detection step (step ii) with which it is detected whether and, if indicated, where on the sheet-like electrode one or more imperfections are present, has taken place, and that the portions in the scope of this test method have been rated to be without imperfections.

The first edge section, respectively portion, and the second edge section, respectively portion, can be connected to each other such that they meet each other. In this manner, an increase of the thickness in the proximity of the joint due to the joint is avoided, and upon meeting two portions comprising essentially the same thickness at the joint, an essentially constant thickness is achieved.

The first edge section, respectively portion, and the second edge section, respectively portion, may also be connected to each other in an overlapping manner. In this manner, a tighter connection between the edge portions, respectively edge sections to be connected to each other, may be achieved.

In the assembled electrode according to the third aspect, a respective portion may be developed in a slat-like manner. Slat-like portions are particularly easily processable due to their essentially linear edge sections.

The first portion may comprise a first electrode material, and the second portion may comprise a second electrode material. Thus, in the assembled electrode, different advantageous properties of the different electrode materials may advantageously be mixed, respectively combined. For example, in this manner, the property of a low voltage decrease during discharge of the device, the capability for the provision of a particularly high current value during a short period, or the capability for storing a particularly high energy density may be mixed, respectively combined, in advantageous manner in the assembled electrode as advantageous property of the first electrode material with the second electrode material comprising an advantageous property being different therefrom.

The first portion may comprise a first electrode material comprising a first thickness, and the second portion may comprise a second electrode material comprising a second thickness.

The electrode may also comprise three or more slat-like portions that, in particular with respect to their longitudinal axis, are arranged in parallel to each other or are arranged side by side.

In the electrode, a portion comprising a first electrode material, which is developed in a first thickness, and a portion comprising a second electrode material, which is developed in a second thickness, may be alternately arranged.

According to a fourth aspect of the present invention, an electrode of a device operating according to galvanic principles is provided, in particular a lithium-ion cell. The electrode comprises an electrode material that is arranged in a sheet-like manner. According to the invention, the electrode material comprises a one-piece portion without imperfections. Also here the term “without imperfection” means that the portion, which is required to be without imperfections, has been rated as result of a test method in which has been detected whether and, if indicated, where on the sheet-like electrode one or more imperfections are present. In other words, the whole surface of the electrode material has been rated to be without imperfections, and is assembled as one-piece, i.e., is not assembled of several portions without imperfections, so that there is also no joint present due to an assembling step.

An electrode according to the third, respectively fourth aspect of the present invention, may comprise a separator material, which overlaps all portions of the electrode, and which is developed in a sheet-like manner. By means of combining the electrodes comprising the one-piece separator material, the electrode is prepared for the further processing, respectively for the construction of a device operating according to galvanic principles.

The electrode according to the third, respectively fourth aspect of the present invention may be coiled up, at least in portions, respectively convolved, wherein a compact construction of the electrode is achieved.

In an alternative compact construction, the electrode may be folded in regular distances and along folding lines, which are essentially arranged in parallel towards each other alternating in a first direction and in a second direction, which is opposite to the first direction, and may comprise an arrangement one upon the other of sections, which are arranged one upon the other, and which are connected along a folding line, respectively. In this manner, an electrode is provided, which is folded in the manner of an accordion and which originally was sheet-like, that is an electrode comprising a M-form in cross-section. In said construction, in particular between two respective sections, which are arranged one upon the other, separator material, which is developed in a sheet-like manner, may be arranged, in particular in the form of sheets of separator material, which are arranged between the respective sections that are arranged one upon the other, in particular that are congruently arranged with respect to the sections that are arranged one upon the other. Such an electrode that is provided with separator material is provided for the construction, respectively for the use, in a device operating according to galvanic principles.

Furthermore, a device operating according to galvanic principles is provided, in particular a lithium-ion cell, comprising an arrangement one upon the other comprising the following layers: as first layer a first electrode without imperfections, which in particular has been made according to a method according to the first, respectively second aspect of the present invention, and which comprises at least two assembled portions without imperfections, as second layer a separator layer comprising a separator material, which is developed in a sheet-like manner, and as third layer a second electrode without imperfections, which in particular has been made according to a method according to the first, respectively second aspect of the present invention, which comprises a one-piece portion, and which is complementary to the first electrode. Thereby, the separator layer is arranged between the first electrode and the complementary second electrode, and overlaps the first, respectively the second electrode. In said device, an assembled electrode without imperfections is combined with a one-piece electrode without imperfections, which is advantageous in the meaning of an increased efficiency, if the electrode material of the assembled electrode has a relatively high number of imperfections due to the making process, since the imperfections are removed, and the portions without imperfections have been assembled to an electrode, which all in all is without imperfections.

Still further a device operating according to galvanic principles, in particular a lithium-ion cell, is provided, which comprises an arrangement one upon the other comprising following layers: as first layer a cathode without imperfections, which comprises at least two assembled portions without imperfections, as second layer a separator layer comprising a separator material, which is developed in a sheet-like manner, and as third layer an anode without imperfections comprising at least two assembled portions without imperfections. Thereby, the separator layer is arranged between the cathode and the anode and overlaps the cathode, respectively the anode. In particular, the cathode, respectively the anode, may have been made according to the method according to the first, respectively the second aspect of the present invention.

The cathode may have three or more slat-like portions, and the anode may have slat-like portions in the same number compared to the cathode, wherein the portions of the cathode and the portions of the anode are congruently arranged towards each other, respectively.

The cathode may alternately exhibit portions comprising a first cathode material, which is developed in a first thickness, and portions comprising a second cathode material, which is developed in a second thickness. Furthermore, the anode may alternately exhibit portions comprising a first anode material, which is developed in a third thickness, and portions comprising a second anode material, which is developed in a fourth thickness.

The first cathode material may be the same as the second cathode material. The first anode material may be the same as the second anode material.

In an arrangement one upon the other, portions of the cathode comprising the cathode material in the relatively larger thickness may congruently be arranged with regard to the portions of the anode comprising the anode material in the relatively larger thickness. Alternatively, in the arrangement one upon the other, portions of the cathode comprising the cathode material in the larger relative thickness may be congruently arranged with regard to the portions of the anode comprising the anode material in the relatively smaller thickness.

For the before-mentioned advantageous embodiments of the device operating according to galvanic principles, the same, respectively similar advantages have to be mentioned as already described above for the presentation of the respective advantageous embodiments of the method according to the first, respectively second aspect of the invention.

Further advantageous embodiments and advantages of the invention result from the attached drawings. Therein show:

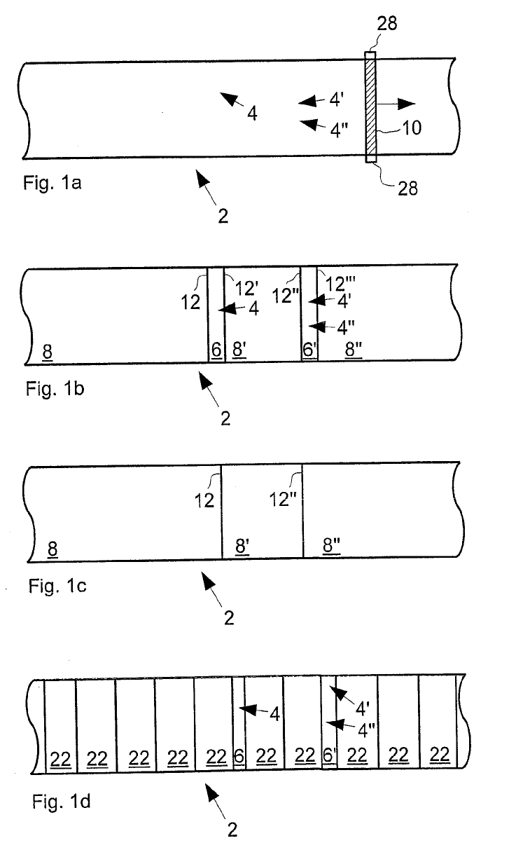

FIG. 1 a to 1d top views onto a sheet-like electrode in different phases of the making method according to the invention;

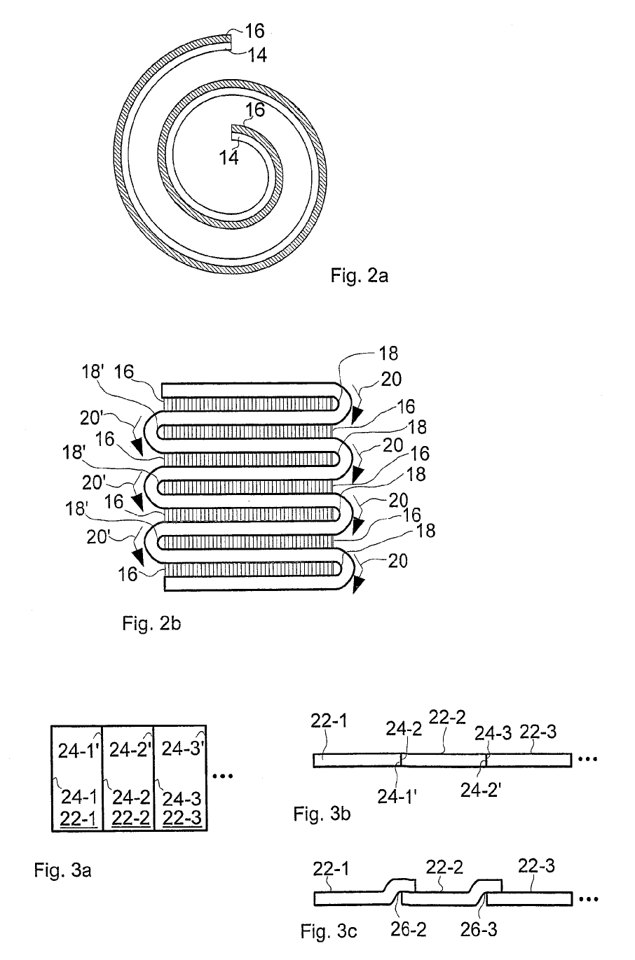

FIG. 2 cross-section views of compact constructions of an electrode according to the invention, FIG. 2a a coiled-up electrode, and FIG. 2b an electrode comprising a M-shaped cross-section, respectively an electrode, which is folded in an accordion-like manner;

FIG. 3 different embodiments of an assembled electrode, in particular FIG. 3a a top view onto an electrode, which is assembled from portions, FIG. 3b a cross-section by portions meeting each other, and FIG. 3c a cross-section by partially overlappingly assembled portions;

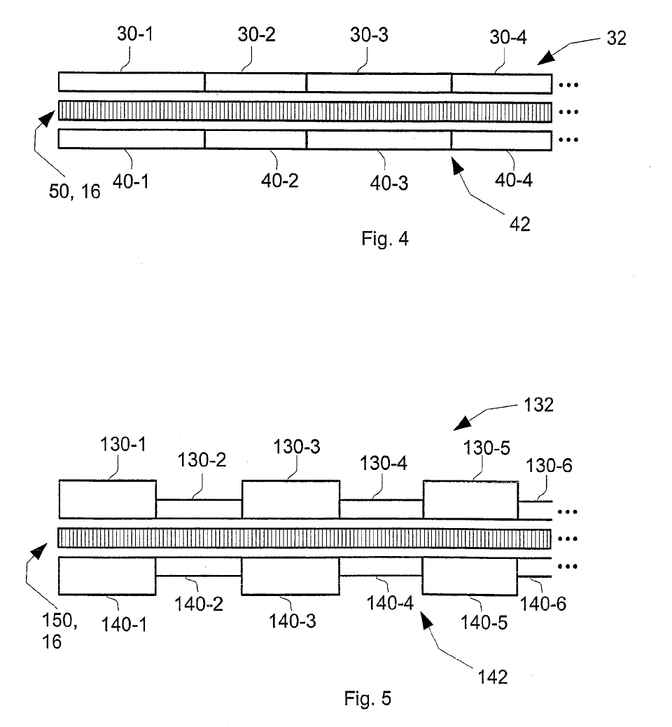

FIG. 4 a cross-section through a device operating according to galvanic principles in a first embodiment according to the invention; and

FIG. 5 a cross-section through a device operating according to galvanic principles in a second embodiment according to the invention.

FIG. 1a shows a top view onto a sheet-like electrode 2, which has been made in a web-like manner in a making step in a making device (not shown). For the testing whether and, if indicated, where on the sheet-like electrode 2 one or more imperfections 4, 4′, 4″ are present, in implementing the detection step (step ii), a measurement window 28 of a detection device (not shown) is moved in longitudinal direction of the web-like electrode 2 (in FIG. 1a in direction of the arrow showing to the right side) from a measuring position to a respective next measuring position, and in the respective measuring position in a region 10 of the surface of the web-like electrode a measuring process is carried out in order to detect whether and where in the measurement window 28, respectively in the region 10 of the surface, which is recorded by the measurement window 28, of the layer, which is formed from the electrode material, an imperfection is present. In the different measuring positions, the respective corresponding measurement window 28, respectively regions 10 of the surface, may be adjacently arranged to each other, or may be partially overlappingly arranged towards each other in order to achieve a redundancy. In performing the detection step, in the measurement window, already scanned regions of the surface of the web-like electrode imperfections 4, 4′, 4″ have been detected, and the respective positions have been determined and recorded,

The precise type of the measurement method is not essential for the invention. For example, the measurement method can be an optical method, a microscopic method, a method, which comprises the measurement of the electric conductivity of regions of the electrode layer, a method, which comprises the measurement of the dielectric capacity of regions of the electrode layer, or combinations thereof, as described in general above.

Also the form of the measurement window, and the sequence, respectively the scanning type, in which the measurement window consecutively records different regions of the surface of the electrode layer, is not essential for the invention as long as the sheet-like, here in particular web-like electrode, is completely measured, respectively scanned. The measurement window 28 can be a slat-like measurement window, as shown in FIG. 1a which completely overlaps the width of the sheet-like electrode, and is moved in one longitudinal direction over the web-like sheet-like electrode. However, it may also be a measurement window comprising a largest dimension (width, respectively length), which is smaller than the smallest dimension (width, respectively length) of the sheet-like electrode which, for example, scans the total surface of the sheet-like electrode line by line by line in lines, which are arranged side by side or which are partially overlapping.

As shown in FIG. 1b, for a respectively detected imperfection 4, 4′, 4″, in the example a slat-like surrounding 6, 6′ is determined, which contains one or more imperfections. The size and form of the surrounding containing an imperfection may be individually selected for a respective imperfection. In the example, for simplification, a slat-like surrounding comprising a predetermined dimension (width) is selected, which exhibits respective edges 12, 12′, respectively 12″ and 12′″.

Then, a respective surrounding 6, 6′ including the imperfection is removed, which is contained in the surrounding (imperfection 4 in the surrounding 6, imperfections 4′, 4″ in the surrounding 6′). For the removal, a respective surrounding 6, 6′ is detached along its edge, respectively along separation lines 12, 12′, 12″, for example stamped out or cut out. Subsequently, the remaining portions 8, 8′ and 8″ are assembled without imperfections at the gaps, which have been generated by the removal of the surroundings, along the separation lines, as shown in FIG. 1c.

The procedure shown in FIGS. 1b and 1c for the detection and removal of surroundings of imperfections has the target to keep intact one-piece portions 8, 8′, 8″, which are as large as possible, which have no imperfections. Then, these portions are assembled to a relatively large-scaled electrode, which all in all is without imperfections, as shown in FIG. 1c.

In another embodiment of the method for detecting and removing imperfections, as shown in FIG. 1d, the regions of the sheet-like electrode, which have been rated in the testing to be without imperfections (in the detection step, step ii), are divided into uniform, in the example slat-like portions 22, and the portions 22 without imperfections are provided for the subsequent processing, that is for the assembling and construction of electrodes without imperfections. In proximity of imperfections 4, 4′, 4″, in this alternative, surroundings 6, 6′ are determined such that from the regions of the surface without imperfections as many as possible uniform portions 22 are defined and may be detached.

Large one-piece regions, which have been rated in the testing step (detection step, step ii) to be without imperfections, or large-scale regions, which have been obtained after the removal of imperfections and by assembling of regions without imperfections, are further processed in more compact designs as shown in FIG. 2 for the assembly into devices operating according to galvanic principles. In order to obtain the design shown in FIG. 2a, onto an electrode without imperfections, which has been made according to the above-described method (for example with regard to FIGS. 1a to 1c), a layer from separator material 16 is applied that is provided in a sheet-like manner. Then the sheet-like electrode comprising the applied separator material 16 is at least coiled up in a portion 14 of the electrode, as shown in FIG. 2a. The coiling up can also be carried out in a manner that consecutive windings of the role may contact each other such that essentially no clearances are generated.

Alternatively to the design of an electrode comprising inserted sheet-like separator material 16 as presented in FIG. 2a, a sheet-like electrode as such, that is without applied separator material, may be coiled up and, if necessary for the application, can be wrapped in the coiled-up condition with separator material, which is provided in a sheet-like manner.

As shown in FIG. 2b, an electrode, which is provided in the form of a web, may be folded in regular distances, respectively, along folding lines 18, 18′, which are in essential arranged in parallel towards each other, alternating in a first direction 20 and into a second direction 20′, which is opposite to the first direction, and may be transformed into an accordion-like structure, which is M-shaped in the cross-section. The structure, respectively design, shown in FIG. 2b, shows a stack of sections, which are arranged one upon the other, and which are connected to each other along the folding lines 18, 18′, respectively, of the sheet-like electrode. Between the respective sections of the sheet-like electrode, which are arranged one upon the other, sheets of separator material 16 are inserted that are developed in a sheet-like manner. The thus obtained compact design of the electrode, as shown in FIG. 2b, is prepared for the assembly into a device operating according to galvanic principles.

FIG. 3 shows different views of an electrode without imperfections, which is obtained by assembling of several portions without imperfections, in the shown example in particular three, uniform, portions 22′1, 22′2 and 22′3. The uniform portions 22′1, 22′2 and 22′3 have been provided with reference to the method as described in FIG. 1d. The portions 22′1, 22′2 and 22′3 may originate from an electrode, which originates from a making process, however, they may also originate from sheet-like electrodes, which have been made with different electrode material, or in different thickness of electrode material. For combining sections, which originate from differently provided sheet-like electrodes, and assembling the same to an electrode without imperfections, it is advantageous that the portions 22 to be assembled are positively developed along the assembling joints, for example slat-like comprising linear edge sections in longitudinal direction, respectively.

The portions 22′1, 22′2 and 22′3 may be assembled such that a respective section 22′1, 22′2 comprising an edge 24-1′, 24-2′ is brought into contact at a positive edge 24′2, 24′3 of a section to be adjacently connected, and is assembled with said section as shown in FIG. 3b.

Edge sections of sections 22-1, 22-2, 22-3 to be adjacently assembled may also be assembled such that a respective edge section of a portion overlaps a respective edge section of the portion to be added such that overlapping portions 26-2, 26-3 are generated, and in which the portions 26-2, 26-3 are connected to each other, as shown in FIG. 3c.

FIG. 4 exemplarily shows an application probability for electrodes, which are assembled from several portions, in a device operating according to galvanic principles, which is assembled from said electrodes. An interconnection shown in FIG. 4 for the construction of a device operating according to galvanic principles comprises an arrangement one upon the other of three layers: a cathode 32 as first layer, a separator layer 50 from separator material 16 that is provided in a sheet-like manner as second layer, and an anode 42 as third layer. The separator layer 50 is arranged such between the cathode 32 and the anode 42 that it covers the whole area. The cathode 32 consists of several assembled, sheet-like portions 30′1, 30′2, 30′4 . . . , and the anode 42 consists of several assembled, sheet-like portions 40′1, 40′2, 40′3, 40′4 . . . . In the arrangement one upon the other, portions 30-1, 30-2, 30-3, 30-4 of the cathode 32, facing each other, are congruently arranged to respective facing portions 40-1, 40-2, 40-3, 40-4 of the anode 42, respectively. For the formation of the cathode 32, portions 30-1, 30-3 of a first cathode material, and portions 30-2, 30-4 of a second cathode material are alternately assembled. For example, the first cathode material is characterized in that by use in a cell operating according to galvanic principles in the charged condition of the cell, a particularly high energy storage density is achieved. For example, the second cathode material is characterized in that by use in a cell during a discharge, short-termed particularly high current peak values may be achieved. The cathode 32 combines, respectively mixes thus an advantageous property of the first cathode material (for example, here a high energy storage density) with an advantageous property of the second cathode material, which is different therefrom (for example, here a high achievable current peak values).

Accordingly, the anode 42 comprises alternately arranged portions 40′1, 40′3 comprising a first anode material, and portions 40′2, 40′4 comprising a second anode material. The first anode material is selected to optimally cooperate with the first cathode material such that by use in a device operating according to galvanic principles a high energy storage density is achieved. The second anode material is selected such to optimally cooperate with the second cathode material such that in the application in a device operating according to galvanic principles particularly high current peak values may be achieved.

FIG. 5 shows an interconnection for the assembly of a device operating according to galvanic principles according to a second embodiment. The interconnection comprises an arrangement one upon the other of a cathode 132 comprising several portions 130-1, 130-2, 130-3, 130-4, 130-5, 130-6, a separator layer 150, which essentially consists of a separator material 16 that is provided in a sheet-like manner, and an anode 142 comprising several portions 140-1, 140-2, 140-3, 140-4, 140-5, 140-6. In the cathode 132, portions 130-1, 130-3, 130-5 comprising a larger thickness of the cathode material, and portions 130-2, 130-4, 130-6 comprising a smaller thickness of the cathode material, are assembled. Correspondingly, in anode 142 portions 140-1, 140-3, 140-5 comprising anode material comprising a relatively larger thickness, and portions 140-2, 140-4, 140-6 comprising anode material comprising a relatively smaller thickness, are alternately assembled. The cathode material in the respective relatively thicker portions 130-1, 130-3, 130-5 (first cathode material) is different from the cathode material in the respective thinner portions 130-2, 130-4, 130-6 (second cathode material). The anode material in the respective relatively thicker portions 140-1, 140-3, 140-5 of anode 142 (first anode material) is different from the anode material of the respective thinner portions 140-2, 140-4, 140-6 (second anode material). In the arrangement one upon the other, the respective thicker, respectively thinner portions of the cathode 132, are congruently arranged with regard to the respective thicker, respectively thinner portions of anode 142. The first cathode material and the first anode material are developed such and combined with each other such that in the cooperation during the operation of a device operating according to galvanic principles as shown in the interconnection of FIG. 5, a first advantageous, particularly developed property is shown, for example a high energy storage density, or a particular low voltage decrease during discharge. The second cathode material and the second anode material are selected such that they show in the cooperation another advantageous, particularly developed property, for example that they temporarily can provide a particularly high discharge current peak value.

The combination, respectively mixing of different advantageously developed operation properties of a cathode material, respectively anode material, may be realized thereby that a cathode, which is assembled from partial sections of different cathode material, may be combined with an anode, which is constructed only from one anode material, and in particular a non-assembled anode, which is constructed from a single region without imperfections, or that vice versa an anode, which is assembled from several sections comprising different anode material, is combined with a cathode comprising only one non-assembled section, which is a non-assembled section, i.e., an in essential one-piece section.

All features that are disclosed in the submissions are claimed to be essential according to the invention provided that they are individually novel or in combination novel over the prior art.

### REFERENCE NUMERALS

2 sheet-like electrode
4, 4′, 4″ imperfection
6, 6′ in particular slat-like surrounding of an imperfection
8, 8′, 8″ portion without imperfection
10 region
12, 12′, 12″, 12′″ separation line, respectively edge
14 coiled up portion
16 separator material
18, 18′ folding line
20, 20′ folding direction
22-1, 22-2, 22-3 . . . slat-like portion
24-1, 24-1′ edge, respectively edge section, of a first slat-like portion
24-2, 24-2′ edge, respectively edge section, of a second slat-like portion
24-3, 24-3′ edge, respectively edge section, of a third slat-like portion
26-1, 26-2, 26-3 . . . overlapping region of the first, second, third . . . portion
28 measurement window
30-1, 30-2, 30-3 . . . portion comprising a cathode material
32 cathode (first embodiment)
40-1, 40-2, 40-3 . . . portion comprising anode material
42 anode (first embodiment)
50 separator layer
130-1, 130-2, 130-3 portion comprising cathode material
132 cathode (first embodiment)
140-1, 140-2, 140-3 portion comprising anode material
142 anode (second embodiment)
150 separator layer

1. Method of making an electrode for a device operating according to galvanic principles, in particular a lithium-ion cell, comprising:
(i) making a sheet-like electrode;
(ii) detecting where on the sheet-like electrode one or more imperfections are present, and
(iii) for a respectively detected imperfection, removing a surrounding of the imperfection including said imperfection.

2. Method according to claim 1, wherein based on the result of the detection step, additionally at least a portion of the sheet-like electrode without imperfection is provided.

3. Method according to claim 1 wherein the step of making the sheet-like electrode is made in a web-like manner, for example, in a continuous method.

4. Method according to claim 1 wherein the step of making the sheet-like electrode is made in the form of a sheet, for example, in a stacking method.

5. Method according to claim 1, wherein the step of detecting is selected from a group consisting of: an optical method, a method comprising the analysis of microscopically magnified images of regions of the sheet-like electrode, a method comprising the measurement of a dielectric capacity of regions of the sheet-like electrode, and a combinations thereof.

6. Method according to claim 5, wherein said optical method of detecting imperfection comprises:
recording an image, in particular in reflection or transmission, of a region of the sheet-like electrode, and
detecting a local deviation of a value of an image parameter that in particular is indicative for an imperfection, for example, brightness or contrast, of an average value of the image parameter, which has been determined across a relatively large area.

7. Method according to claim 6, wherein the method comprising said measurement of the electric conductivity comprises:
measuring an electric resistance of a region of the sheet-like electrode, in particular a slat-like region particularly in longitudinal direction thereof.

8. Method according to claim 6, wherein the method comprising said analysis of microscopically magnified images comprises:
recording a magnified image of a region of the sheet-like electrode, in particular by means of an optical microscope or a scanning electron micrograph, and
by means of in particular sequential recording of images in several, suitably positioned regions, scanning the surface of the sheet-like electrode.

9. Method according to claim 6, wherein the method comprising measurements of the dielectric capacity comprises:
measuring the dielectric capacity of a respective region of the sheet-like electrode, which is within a measurement window, and
by in particular sequential measuring of the dielectric capacity in several, suitably positioned measurement windows, respectively regions, scanning the surface of the sheet-like electrode.

10. Method according to claim 1, wherein the making step comprises the application of a layer of an electrode material, in particular a cathode material or an anode material, onto a substrate, in particular onto a material diverting an electric current, such as a metal foil.

11. Method according to claim 10, wherein in a removal step, the section of the layer of the electrode material, which contains the imperfection, is removed from the substrate, and a fresh electrode layer is applied onto the substrate in the uncovered section, an that in the fresh electrode layer it is in particular subsequently detected whether and where one or more imperfections are present therein.

12. Method according to claim 1, wherein in a removal step a region of the sheet-like electrode, which contains the imperfection, is removed from the sheet-like electrode, and is replaced by a region without imperfection of the same or another sheet-like electrode, which corresponds to the form of the removed region.

13. Method according to claim 1, wherein in a removal step a slat of the sheet-like electrode, which comprises a detected imperfection, is detached from the sheet-like electrode along parallel separation line, for example, is cut out or stamped out.

14. Method according to claim 13, wherein if in said detaching of the region of the sheet-like electrode (2), which contains a detected imperfection, two portions are created, which contain no imperfection, the created portions are assembled along the separation line.

15. Method according to claim 1, further comprising:
assembling two sections without imperfections of the same sheet-like electrode, or two sections without imperfections, which have been detached from two different sheet-like electrodes, along the respective edges, respectively separation lines of the sections.

16. Method according to claim 15, wherein the step of assembling comprises a contacting of the edges in a stack-like manner of the sections to be assembled.

17. Method according to claim 15, wherein the step of assembling comprises an overlapping contacting of respective edge slats, which in particular run along the edges of the sections to be assembled.

18. Method according claim 1, wherein after the removal step at least a portion of the sheet-like electrode is coiled up.

19. Method according claim 1, wherein after the removal step a layer of a separator material is applied onto at least one region of the sheet-like electrode, and at least a portion of the region, which has been provided with the applied separator material of the sheet-like electrode, is coiled up.

20. Method according claim 1, wherein after the removal step, further comprising:
alternately folding the sheet-like electrode in regular distances and along folding lines, which essentially are arranged in parallel towards each other, into a first direction and into a direction, which is opposite to the first direction,
forming a stack of sections of the sheet-like electrode, which are arranged one upon the other, and which are connected along a folding line, respectively, and in particular furthermore
inserting separator material that is developed in a sheet-like manner, in particular in the form of sheets of separator material, which are congruently developed with respect to two respective sections, which are arranged one upon the other, between the respective sections of the sheet-like electrode, which are arranged one upon the other.

21. A method of making an electrode for a device operating according to galvanic principles, in particular a lithium-ion cell, comprising:
(i) making a sheet-like electrode,
(ii) detecting where on the sheet-like electrode one or more imperfections are present, and
(iii) based on the result of the detection step, providing at least one portion without imperfections of the sheet-like electrode.

22. Method according to claim 21, further comprising:
connecting at least one section of an edge of a first portion without imperfections of the sheet-like electrode to at least one section of an edge of a second portion without imperfections of the same electrode, or of a second sheet-like electrode, along respective positive sections of the edges, which in particular are at least sectionally linear, of the first and second portion.

23. Method according to claim 22, wherein the first and the second portion and a third portion without imperfections of the first, second or third sheet-like electrode are developed in a slat-like manner, respectively, and that the method further comprises: connecting at least a section of the edge of the third portions to at least one section of the edge of the second portion, which faces the section of the edge of the second portion, which is connected to the first portion.

24. Method of making a device operating according to galvanic principles, in particular a lithium-ion cell, comprising:
forming an arrangement one upon the other of:
a region of a sheet-like electrode comprising cathode material without imperfections according to claim 21, wherein,
a separator material that is provided in a sheet-like manner, and
a region of a sheet-like electrode comprising anode material without imperfections.

25. Method of making a device operating according to galvanic principles, in particular a lithium-ion cell, comprising:
connection two, three, four of more portions of a sheet-like electrode without imperfections, and forming an electrode, which is assembled from portions, in particular cathode (32) or anode,
forming an arrangement one upon the other comprising the assembled electrode, in particular cathode or anode, as first layer, a separator layer from separator material that is provided in a sheet-like manner as second layer, and an electrode, which is made from a one-piece portion without imperfections, and which is complementary to the assembled electrode, in particular anode or cathode, as a third layer.

26. Method of making a device operating according to galvanic principles, in particular a lithium-ion cell, comprising:
connecting two, three, four of more portions without imperfections of sheet-like electrodes comprising cathode material, and forming a sheet-like cathode, which is assembled from the portions,
connecting two, three, four, respectively more portions without imperfections of sheet-like electrodes comprising anode material, and forming a sheet-like anode, which is assembled from the portions, and
forming an arrangement one upon the other consisting of the assembled cathode as first layer, a separator layer from separator material that is provided in a sheet-like manner as second layer, and the assembled anode as third layer.

27. Method according to claim 26, wherein the two, three, four, respectively more portions comprising anode material have been congruently developed to the respective two, three, four, respectively more portions comprising cathode material, and that the respective portions comprising cathode material, which are congruently anode material, are congruently arranged one upon the other in the arrangement one upon the other comprising separator material, which is arranged between.

28. Method according to claim 26, wherein the two, three, four, or more portions comprising cathode material, and the two, three, four, respectively more portions comprising anode material are slat-like portions, respectively.

29. Method of making a device operating according to galvanic principles, in particular a lithium-ion cell, comprising:
providing first slat-like portions without imperfections comprising a first cathode material,
providing second slat-like portions without imperfections comprising a second cathode material,
providing first slat-like portions without imperfections comprising a first anode material,
providing second slat-like portions without imperfections comprising a second anode material,
forming a sheet-like cathode of portions, which are arranged in parallel towards each other and which are connected to each other, wherein the first portions comprising the first cathode material, and the second portions comprising the second cathode material, are alternately connected to each other,
forming a sheet-like anode from portions, which are arranged in parallel towards each other and which are connected to each other, wherein the first portions comprising the first anode material, and the second portions comprising the second anode material, are alternately connected to each other, and
forming an arrangement one upon the other consisting of the cathode as first layer, a separator layer from separator material that is provided in a sheet-like manner as second layer, and the anode as third layer.

30. Method according to claim 29, wherein the respective slat-like portions of the cathode (32), and the slat-like portions of the anode, are congruently arranged one upon the other in the arrangement one upon the other comprising separator material, which is arranged between.

31. Method according to claim 29, wherein the first cathode material and the second cathode material are the same cathode material, respectively that the first anode material and the second anode material are the same anode material.

32. Method according to claim 29, wherein the first slatlike portions of the cathode comprises the first cathode material in a first thickness, and the second slat-like portions of the cathode comprises the second cathode material in a second thickness.

33. Method according to claim 29, wherein the first slat-like portions of the anode comprises the first anode material in a third thickness, and the second slat-like portions of the anode comprises the second anode material in a fourth thickness.

34. Method according to claim 32, wherein, portions comprising the cathode material in the relatively larger thickness are congruently arranged in the arrangement one upon the other with respect to the portions of the anode (42) comprising the anode material in the relatively larger thickness.

35. An electrode, in particular cathode or anode, for a device operating according to galvanic principles, in particular a lithium-ion cell,
comprising electrode material that is arranged in a sheet-like manner, wherein the electrode material is assembled from a first portion without imperfections, and a second portion without imperfections.

36. Electrode according to claim 35, wherein the first portion includes a first edge section, and the second portion includes a second edge section, which is positively developed with respect to the first edge section, wherein the first portion and the second portion are connected to each other along at least sections of the first and second edge section.

37. Electrode according to claim 35, wherein the first edge section and the second edge section are connected to each other such that they meet each other.

38. Electrode according to claim 36, wherein, the first edge section and the second edge section are overlappingly connected to each other.

39. Electrode according to claim 36, wherein a respective portion is slat-like.

40. Electrode according to claim 36, wherein the first portion comprises a first electrode material, and the second portion comprises a second electrode material.

41. Electrode according to claim 36, wherein the first portion comprises a first electrode material comprising a first thickness, and the second portion comprises a second electrode material comprising a second thickness.

42. Electrode according to claim 36, further comprising: three or more portions, which are arranged in parallel towards each other and side by side with respect to their respective longitudinal axis.

43. Electrode according to claim 36, wherein a portion includes a first electrode material, which is developed in a first thickness, and a portion comprising a second electrode material, which is developed in a second thickness, are alternately arranged.

44. Electrode, in particular cathode or anode, for a cell operating according to galvanic principles, in particular a lithium-ion cell, comprising electrode material that is arranged in a sheet-like manner, wherein the electrode material comprises a one-piece portion without imperfections, which in particular has been tested to be without imperfections.

45. Electrode according to claim 36, further comprising: a separator material that is developed in a sheet-like manner, which overlaps all portions.

46. Electrode according to claim 36, wherein said electrode is coiled up.

47. Electrode according to claim 36, wherein it is alternately folded in regular distances and along folding lines, which essentially are arranged in parallel towards each other, into a first direction and into a direction, which is opposite to the first direction, and comprises an arrangement one upon the other of sections, which are arranged one upon the other and are connected along a folding line, respectively, and that in particular furthermore between respective sections, which are arranged one upon the other, separator material that is developed in a sheet-like manner is arranged, in particular in the form of sheets of separator material, which are congruently arranged with respect to the sections that are arranged one upon the other.

48. Device operating according to galvanic principles, in particular a lithium-ion cell, wherein said device comprises an arrangement one upon the other of the following layers:
a first electrode without imperfections, which in particular has been made, which comprises at least two assembled portions without imperfections, a separator layer comprising a separator material that is developed in a sheet-like manner, and
a second electrode without imperfections, and which comprises a one-piece portion, and which is complementary to the first electrode,
wherein the separator layer is arranged between the first electrode and the complementary second electrode, and overlaps the first electrode, respectively the second electrode.

49. Device operating according to galvanic principles, in particular a lithium-ion cell,
wherein, it comprises an arrangement one upon the other comprising the following layers:
a cathode (32) without imperfections, and which comprises at least two assembled portions without imperfections,
a separator layer comprising a separator material that is developed in a sheet-like manner, and
an anode without imperfections, and which comprises at least two assembled portions without imperfections,
wherein the separator layer is arranged between the cathode and the anode, and overlaps the cathode, respectively the anode.

50. Device according to claim 49, wherein, the cathode comprises three or more slat-like portions, and the anode comprises slat-like portions in the same number as the cathode, wherein the portions of the cathode and the portions of the anode are congruently arranged towards each other, respectively.

51. Device according to claim 50, wherein, the cathode alternately comprises portions comprising a first cathode material, which is developed in a first thickness, and portions comprising a second cathode material, which is developed in a second thickness, and/or that the anode alternately comprises portions comprising a first anode material, which is developed in a third thickness, and portions comprising a second anode material, which is developed in a fourth thickness.

52. Device according to claim 51, wherein, the first cathode material is the same material as the second cathode material and/or that the first anode material is the same material as the second anode material.

53. Device according to claim 51, wherein portions of the cathode comprising the cathode material in the larger thickness are congruently arranged in the arrangement one upon the other with respect to the portions of the anode comprising the anode material in the larger thickness.

54. Device according to claim 51, wherein portions of the cathode comprising the cathode material in the larger thickness are congruently arranged in the arrangement one upon the other with respect to the portions of the anode comprising the anode material in the smaller thickness.
